(19) United States
(12) Patent Application Publication
(10) Pub. No.: US 2021/0015194 A1
(43) Pub. Date: Jan. 21, 2021

(54) SINGLE-LAYER SHOCK-ABSORBING SPORTS HELMET FORMED BY STEAM

(71) Applicant: EON SPORTING GOODS CO.,LTD., Dongguan (CN)

(72) Inventors: Yujie ZHAO, Dongguan (CN); Yongjun LIN, Dongguan (CN); Jie PENG, Dongguan (CN); Yonggang ZHANG, Dongguan (CN)

(21) Appl. No.: 16/516,224

(22) Filed: Jul. 18, 2019

(51) Int. Cl. A42B 3/06; B32B 7/12; B32B 27/06; B32B 27/32

(52) U.S. Cl. CPC A42B 3/06; B32B 7/12; B32B 2307/558; B32B 27/32; B32B 2437/04; B32B 27/065

(57) ABSTRACT

A single-layer shock-absorbing sports helmet formed by steam, including a hard shell and an EPP layer. The hard shell is fitted and bonded with the EPP layer by glue, and the hard layer covers an outer surface of the EPP layer. The EPP layer is made of an EPP material which is waterproof and heat resisting and insulating, such that the wearing comfort of the helmet is effectively improved. The hard shell and the EPP layer are bonded by glue, so less materials are used, thus the weight and cost will be reduced without affecting the use of the helmet. In addition, the helmet also has excellent impact resistance.

### TECHNICAL FIELD

The present application relates to sports equipment, particularly to a sports helmet, more particularly to a single-layer shock-absorbing sports helmet formed by steam.

### BACKGROUND OF THE INVENTION

A helmet is a protective gear for protecting the head. Helmets are indispensable to sports and transportation, and are usually used for users in recreational activities and sports such as cycling, polo, climbing, auto racing, motorcycling, skiing, American football, hockey, baseball, lacrosse, off-road motorcycle racing, parachuting and snow or aquatic sports (e.g. snowboarding); and workers in work activities such as construction or in dangerous environments. The helmet is mostly of a hemispherical shape comprising a shell and a lining, and a shock-absorbing structure is provided therebetween. The shock-absorbing structure is required to have sufficient rigidity for resisting impact and inflexibility for cushioning. However, this cannot be achieved by the same material due to the same density, and as a result, various materials are adopted so that the helmet is complicated in structure, and is heavy and uncomfortable to wear.

### SUMMARY OF THE INVENTION

The present application provides a single-layer shock-absorbing sports helmet formed by steam. It is comfortable to wear and has both rigidity for resisting impact and inflexibility, which overcomes the shortcomings of the helmets in the prior art.

The single-layer shock-absorbing sports helmet formed by steam, comprising a hard shell, and an EPP layer. The hard shell is snugly bonded with the EPP layer by glue, and the hard shell covers an outer surface of the EPP layer.

In some embodiments, the EPP layer is made of an EPP material.

The single-layer shock-absorbing sports helmet formed by steam comprises a hard shell and an EPP layer, which has excellent impact resistance and other beneficial performances such as waterproofness and heat resistance and insulation. In addition, properties such as good shock absorption, high deformation recovery rate, good heat resistance, oil resistance and heat insulation are realized by the characteristics of the EPP layer. Moreover, the lightweight EPP layer greatly reduces the weight of the product.

### BRIEF DESCRIPTION OF THE DRAWINGS

The invention is further described with reference to the accompanying drawings, which constitute a part of the detailed description and are intended to illustrate but not to limit the present invention. The present invention will be further understood with reference to the drawings and embodiments.

FIG. 1 is a schematic view from the top showing a single-layer shock-absorbing sports helmet formed by steam according to the present invention;

FIG. 2 is a cross-sectional view taken along A-A line of FIG. 1; and

FIG. 3 is a cross-sectional view taken along B-B line of FIG. 1.

Reference numerals: 1, hard shell; 2, EPP layer.

### DETAILED DESCRIPTION OF EMBODIMENTS

The embodiment of the present invention are described with reference to the drawings. It should be understood that the embodiments herein are intended to illustrate rather than limit the present invention.

### EXAMPLE 1

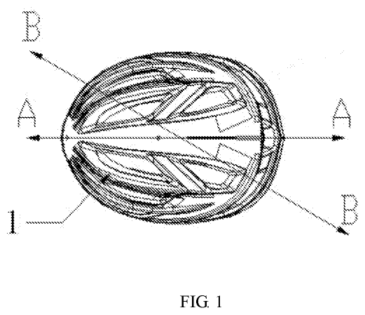

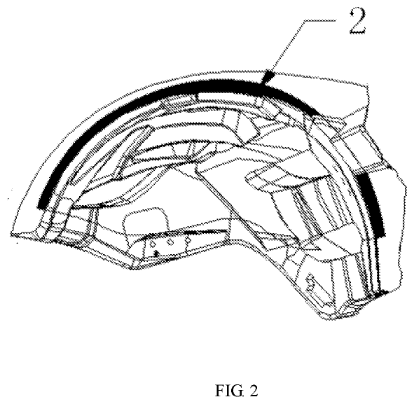

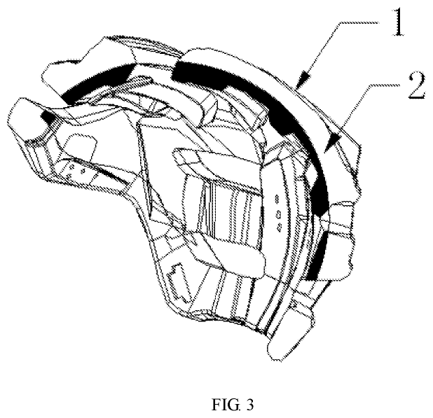

As shown in FIGS. 1-3, illustrated is a single-layer shock-absorbing sports helmet formed by steam, comprising a hard shell 1 and an EPP layer 2. The hard shell 1 is snugly bonded with the EPP layer 2 by glue, and the hard shell 1 covers an outer surface of the EPP layer 2.

The EPP layer 2 is made of an EPP material.

Specifically, the helmet of the present invention is used for helmets for outdoor sports, such as helmets for cycling, and the helmet is also used as vehicle helmets or other sports helmets, such as helmets for baseball, because it is capable of absorbing shock and cushioning using an EPP structure. The helmet is mainly composed of the hard shell 1 and the EPP layer 2. The hard shell 1 is capable of resisting external impact. The EPP layer 2 mainly made of expandable polypropylene is waterproof, and heat resisting and insulating, so the wearing comfort of the helmet is effectively improved. Also, the weight and the cost of the helmet are both reduced since the hard shell 1 and the EPP layer 2 are bonded together by glue and less materials are used.

The manufacturing process of the helmet are described as follows.

1. The hard shell is formed as a single part by die casting with a PC material.

2. The urea-formaldehyde resin, polyimide, ethyl acrylate and polyurethane are mixed in a weight ratio of 3:2:2.5:4 into a paste under stirring at 50-70° C. to form glue, and the hard shell 1 and the EPP layer 2 are well bonded together by such glue.

3. A special glue is sprayed on an inner surface of the hard shell, so that the shell is well bonded with the EPP in the subsequent process.

4. The EPP material is poured into the mold into which the hard shell is placed. and then high-temperature steam is injected into the mold, and under high temperature and high pressure, the EPP material is melted and formed into the EPP layer, and the EPP layer is bonded to the hard shell at the same time.

After completing above processes, the steam is released to reduce pressure and temperature in the mold, and then the helmet is demolded to form the helmet.

The single-layer shock-absorbing sports helmet formed by steam comprises a hard shell and an EPP layer. It is waterproof and heat resisting and insulating, and also has good impact resistance. Other properties such as excellent shock absorption, high deformation recovery rate, good heat resistance, oil resistance and heat insulation are realized by the characteristics of the EPP layer. Moreover, the lightweight EPP material can greatly reduce the weight of the product.

It should be noted that the above description is only a preferred embodiment rather than limitation of the present invention. Although the present invention has been described in detail with reference to the foregoing embodiments, modifications or equivalent substitutions of the technical solutions described in the foregoing embodiments may be made by those skilled in the prior art. Any modifications, equivalent substitutions, improvements within the spirit and scope of the present invention shall fall within the scope of the present invention.

We claim:

1. A single-layer shock-absorbing sports helmet formed by steam, comprising a hard shell and an EPP layer;
wherein the hard shell is snugly bonded with the EPP layer by glue, and the hard shell covers an outer surface of the EPP layer.

2. The helmet of claim 1, wherein the EPP layer is made of an EPP material.
